(19) United States
(12) Patent Application Publication
(10) Pub. No.: US 2007/0230172 A1
(43) Pub. Date: Oct. 4, 2007

(54) Lamp with multiple light emitting faces

(75) Inventor: Pei-Choa Wang, Gueishan Township (TW)

Correspondence Address: HDSL, 4331 STEVENS BATTLE LANE, FAIRFAX, VA, 22033, US

(73) Assignee: Augux Co., Ltd.

(21) Appl. No.: 11/393,816

(22) Filed: Mar. 31, 2006

(51) Int. Cl. F21V 21/00; F21V 29/00

(52) U.S. Cl. 362/249; 362/294; 362/373

(57) ABSTRACT

A lamp with multiple light emitting faces includes a heat-dissipation unit, an isothermal body, a plurality of light-emitting units, a lampshade and a reflection shell. The heat-dissipation unit includes two round hollow casings. The isothermal body is arranged on a bottom face of the heat-dissipation unit and integral with the heat-dissipation unit. The isothermal body includes a plurality of outer planes and each plane is defined with a groove. The light-emitting units are arranged in the groove to provide lamp in multiple planes. The lampshade includes a plurality of heat dissipating plates and an accommodation space is defined at center of the lampshade to accommodate the heat-dissipation unit. The reflection shell is assembled with the heat-dissipation unit and the lampshade and the reflection shell is around the isothermal body.

### BACKGROUND OF THE INVENTION

1. Field of the Invention

The present invention relates to a lamp, especially to a lamp with multiple light emitting faces.

2. Description of Prior Art

Light emitting diode (LED) is a solid-state semiconductor device, where two different carriers are combined as current flows through the diode and light is emitted from the diode as energy transfers from the combination. LED has the advantage of compactness, fast response and contamination-free. Therefore, LED has versatile applications. More particularly, as high-power LED is successfully developed, LED can be used in general-lighting application to replaced tungsten lamp.

As the fabrication technology of LED is enhanced and new material is developed, the high power LED can be manufactured with high brightness and can be applied to various applications.

Even though the power of LED is enhanced, it is still difficult to provide sufficient illumination by only one LED. FIG. 1 shows a prior art LED lamp with a plurality of LEDs. The LED lamp comprises a refection shell 101 with a round supporter 102, a plurality of LEDs 103 arranged on the round carrier 102. The light emitted from the LEDs 103 is focused by reflection the refection shell 101.

However, the supporter 102 used to mount the LEDs 103 uses only single face to mount the LEDs 103. The supporter 102 has limited surface area and the brightness of the LED lamp is hard to enhance. The LED lamp will be bulky and the cost is increased when the area of the supporter 102 is increased.

### SUMMARY OF THE INVENTION

The present invention is to provide a lamp with multiple light emitting faces. An isothermal body with a plurality of planes is provided to mount light emitting units. A reflection shell is provided for light focusing. The lifetime of the lamp is prolonged by the heat dissipation of the isothermal body.

Accordingly, the present invention provides a lamp with multiple light emitting faces. The lamp comprises a heat-dissipation unit, an isothermal body, a plurality of light-emitting units, a lampshade and a reflection shell. The heat-dissipation unit includes two round hollow casings. The isothermal body is arranged on a bottom face of the heat-dissipation unit and integral with the heat-dissipation unit. The isothermal body includes a plurality of outer planes and each plane is defined with a groove. The light-emitting units are arranged in the groove to provide lamp in multiple planes. The lampshade includes a plurality of heat dissipating plates and an accommodation space is defined at center of the lampshade to accommodate the heat-dissipation unit. The reflection shell is assembled with the heat-dissipation unit and the lampshade and the reflection shell is around the isothermal body. The light emitted from the light-emitting units is focused by the reflection shell to provide high brightness.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a section view of prior art LED lamp.

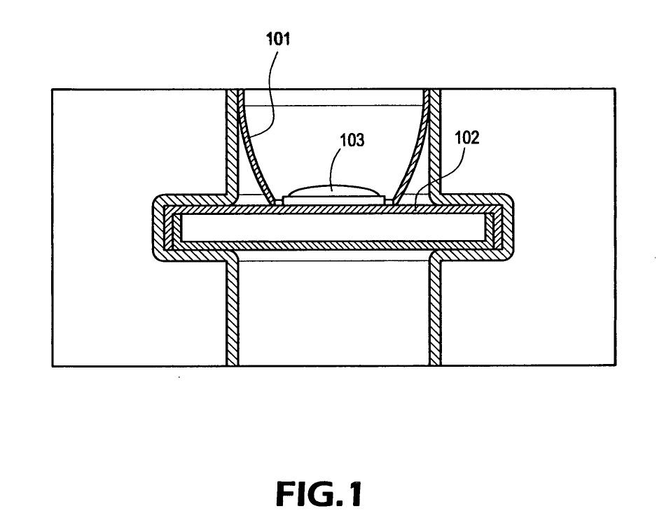

FIG. 2 shows an exploded view of the present invention.

FIG. 3 shows the operation of the lamp according to the present invention.

FIG. 4 shows a partially enlarged figure of the isothermal body.

FIG. 5 shows the isothermal body according to another preferred embodiment of the present invention.

FIG. 6 shows a schematic view of heat dissipation in the lamp according to the present invention.

### DETAILED DESCRIPTION OF THE INVENTION

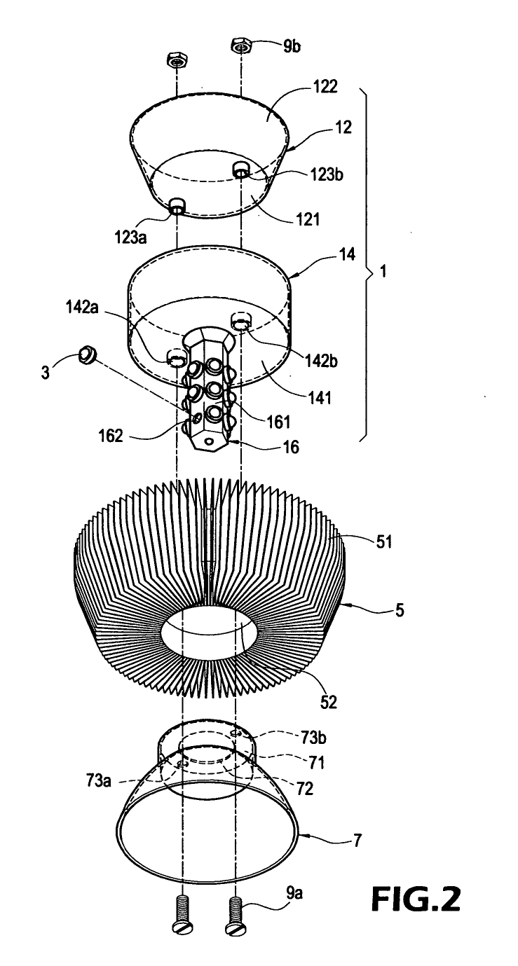

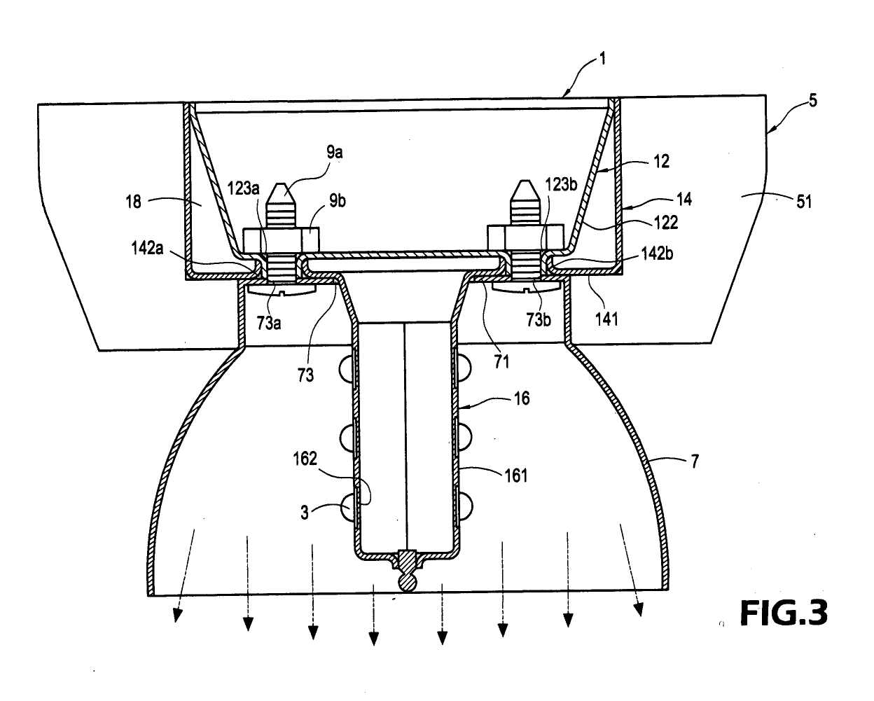

FIG. 2 shows an exploded view of the present invention. The LED lamp according to the present invention comprises a heat-dissipation unit 1, at least one light-emitting unit 3, a lampshade 5 and a reflection shell 7. The heat-dissipation unit 1 comprises a first casing 12, a second casing 14 and an isothermal body 16. The first casing 12 is a round hollow casing and comprises a lower face 121, which is smaller than an upper face 122 of the first casing 12. Convex holes 123a and 123b are defined on the lower face 121 and through the lower face 121. The second casing 14 is also a round hollow casing and matched with the first casing 12. Concave holes 142a and 142b are defined on a bottom face 141 of the second casing 14. When the first casing 12 is assembled with the second casing 14, namely, the first casing 12 is placed within the second casing 14, the convex holes 123a and 123b are fit with the concave holes 142a and 142b. An annulus space 18 is defined between the first casing 12 and the second casing 14, as shown in FIG. 3.

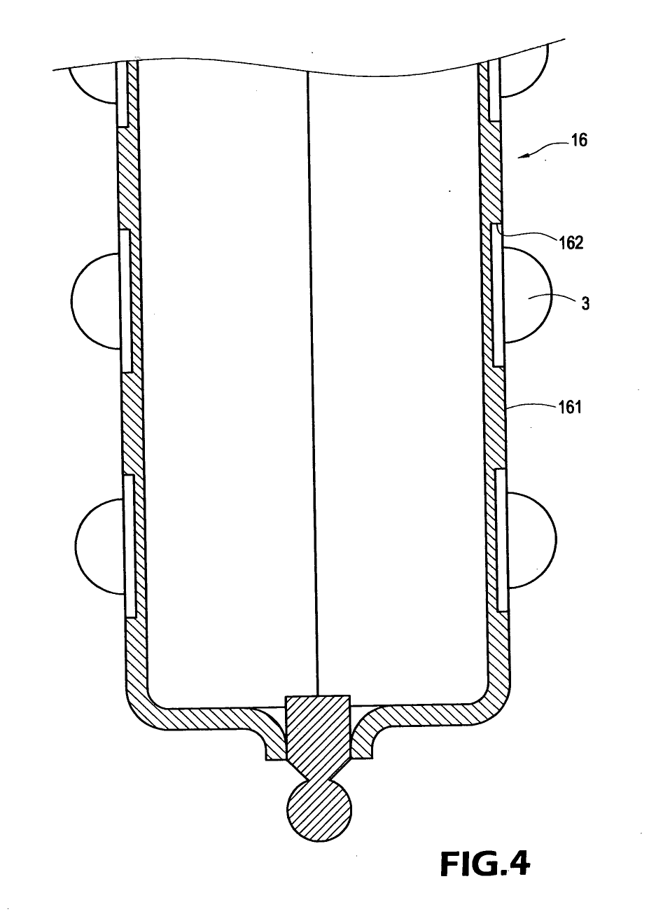

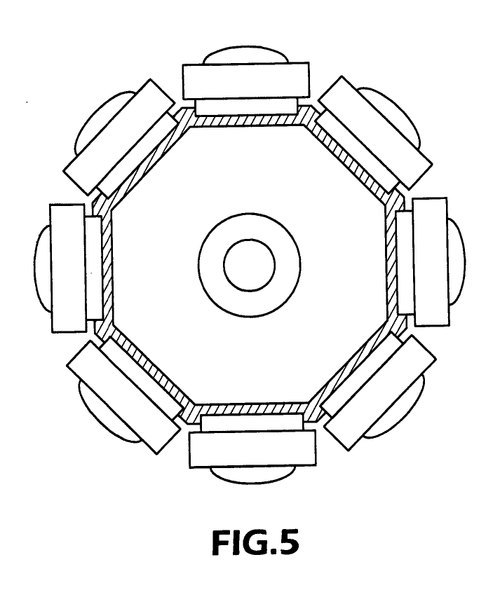

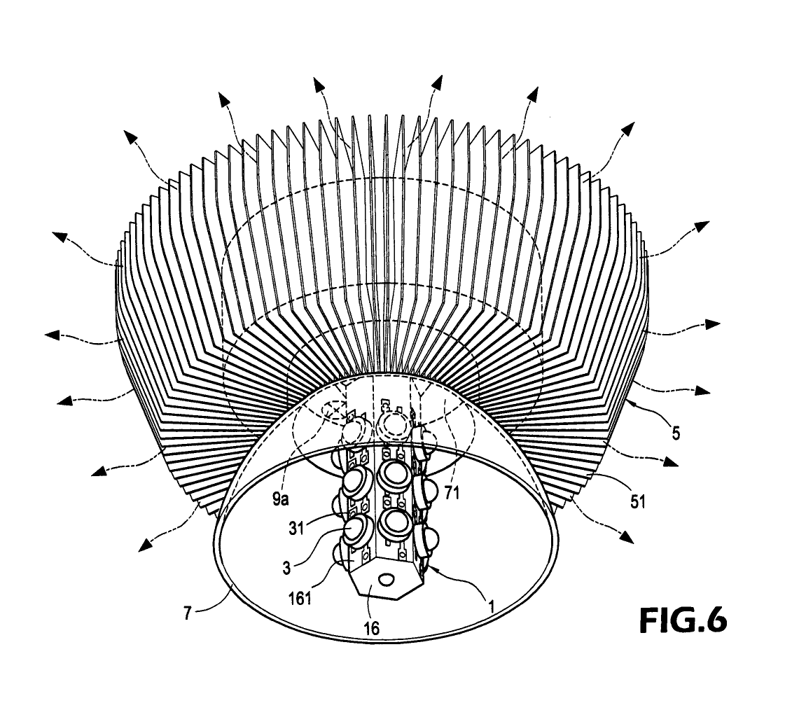

Moreover, the isothermal body 16 is arranged on the bottom face 141 of the second casing 14 and integral with the second casing 14. The isothermal body 16 is an elongated hollow cylinder and used to conduct heat to the heat-dissipation unit 1. The isothermal body 16 is communicated with the annulus space 18. The isothermal body 16 and the annulus space 18 are in vacuum state and filled with wick structure and working fluid. However, this is well known art and the detailed description is omitted here. The isothermal body 16 is a polygon cylinder such as the octagon cylinder shown in FIG. 5. In the preferred embodiment shown in FIG. 2, the isothermal body 16 is a hexagon cylinder and has six identical planes 161. Each of the planes 161 is defined with at least one round groove 162. In the preferred embodiment shown in FIG. 2, there are three round grooves 162 defined on the plane 162. FIG. 4 shows a partially enlarged figure of the isothermal body 16, each of the round grooves 162 is assembled with a light-emitting unit 3. In the shown preferred embodiment, the light-emitting unit 3 is realized by LED. The light-emitting unit 3 is connected to power source through the electrode pin 31 thereof, where the electrode pin 31 is extended along the planes 161, as shown in FIG. 6.

With reference back to FIG. 2, the lampshade 5 is also an annulus body and comprises a plurality of heat-dissipating plates 51. An accommodation space 52 is defined at center of the lampshade 5 and used to enclose the heat-dissipation unit 1. The reflection shell 7 is also a round hollow cylinder and arranged below the lampshade 5. An accommodation hole 72 is defined on top face 71 of the reflection shell 7 and through holes 73a and 73b are defined on both sides of the accommodation hole 72. The positions of the through holes 73a and 73b are corresponding to the concave holes 142a and 142b. Therefore, when the heat-dissipation unit 1 is assembled with the reflection shell 7, the isothermal body 16 is placed into the accommodation space 52 and passes through the accommodation hole 72 for placing into the reflection shell 7. Screw elements 9a and 9b are used to lock the heat-dissipation unit 1 with the reflection shell 7.

FIG. 3 shows the operation of the LED lamp according to the present invention. After the light-emitting unit 3 is powered by an external power source, the light emitted from the light-emitting unit 3 is focused by the reflection shell 7 and projected outward. Therefore, the LED lamp according to the present invention can have high brightness. As shown in FIG. 6, the heat produced during the operation of the light-emitting unit 3 is absorbed by the isothermal body 16. Afterward the heat is conducted to the heat-dissipation unit 1 through the wick structure and working fluid in the isothermal body 16. The heat is then dissipated through the heat-dissipating plates 51 of the lampshade 5, thus ensuring normal operation of the light-emitting unit 3 and prolonging lifetime.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A lamp with multiple light emitting faces, comprising
a heat-dissipation unit comprising a first casing and a second casing, an annulus space defined between the first casing and the second casing, an isothermal body placed on a bottom surface of the second casing and being a hollow cylinder and communicated with the annulus space, the isothermal body comprising a plurality of planes on outer face thereof, each of the plane being defined with a groove thereon; and
light-emitting unit arranged on the groove.

2. The lamp with multiple light emitting faces as in claim 1, wherein the first casing and the second casing are hollow casings.

3. The lamp with multiple light emitting faces as in claim 1, wherein the annulus space is filled with wick structure and working fluid.

4. The lamp with multiple light emitting faces as in claim 1, wherein the isothermal body is integral with the second casing.

5. The lamp with multiple light emitting faces as in claim 1, wherein the isothermal body contains wick structure and working fluid therein.

6. The lamp with multiple light emitting faces as in claim 1, wherein the isothermal body is hexagon cylinder.

7. The lamp with multiple light emitting faces as in claim 1, wherein the isothermal body is octagon cylinder.

8. The lamp with multiple light emitting faces as in claim 1, wherein the light-emitting unit is light-emitting diode.

9. The lamp with multiple light emitting faces as in claim 1, further comprising a lampshade around the heat-dissipation unit

10. The lamp with multiple light emitting faces as in claim 9, wherein the lampshade comprises a plurality of heat dissipating plates.

11. The lamp with multiple light emitting faces as in claim 1, further comprising a reflection shell on bottom face of the heat dissipation unit.
